(19) United States
(12) Patent Application Publication
(10) Pub. No.: US 2025/0280474 A1
(43) Pub. Date: Sep. 4, 2025

(54) MICROWAVE GENERATION METHOD AND DEVICE

(71) Applicant: SMOORE INTERNATIONAL HOLDINGS LIMITED, George Town (KY)

(72) Inventors: Liang WANG, Shenzhen (CN); Chunlin YANG, Shenzhen (CN)

(21) Appl. No.: 19/210,857

(22) Filed: May 16, 2025

Related U.S. Application Data
(63) Continuation of application No. PCT/CN2023/105267, filed on Jun. 30, 2023.

(30) Foreign Application Priority Data
Nov. 18, 2022 (CN) 202211446901.4

(51) Int. Cl. H05B 6/80; A24F 40/46; A24F 40/57

(52) U.S. Cl. CPC H05B 6/802; A24F 40/46; A24F 40/57

(57) ABSTRACT

A microwave generation method for an aerosol-generating device includes: generating an N^{th} microwave signal by a microwave generation module, N being an integer greater than or equal to 1; detecting a feedback signal corresponding to the N^{th} microwave signal, and generating an adjusting signal according to the feedback signal; and adjusting a control signal according to the adjusting signal by a microwave control module as an adjusted control signal, and sending the adjusted control signal to the microwave generation module.

### CROSS-REFERENCE TO PRIOR APPLICATION

This application is a continuation of International Patent Application No. PCT/CN2023/105267, filed on Jun. 30, 2023, which claims priority to Chinese Patent Application No. 202211446901.4, filed on Nov. 18, 2022. The entire disclosure of both applications is hereby incorporated by reference herein.

### FIELD

The present disclosure relates to the field of microwave atomizers, and in particular, to a microwave generation method and device.

### BACKGROUND

When microwave energy is used for heating aerosol forming substrate to form aerosol, it is difficult for the microwave energy transmitted to the aerosol forming substrate to be completely absorbed. However, there is an optimal working frequency corresponding to the aerosol-forming substrate, and microwave energy using the optimal working frequency can be maximally absorbed by the aerosol-forming substrate, and in addition the amount of reflected microwave energy is the lowest, thereby maximizing the use of energy. In a working process, the resistance characteristic of an aerosol-forming substrate in an resonating cavity changes all the time, and therefore, the optimal working frequency at which the aerosol-forming substrate absorbs the microwave energy also changes. Therefore, the frequency of the microwave energy needs to be adjusted in a timely manner, so as to ensure the maximum utilization of energy.

Currently, microwaves in a particular frequency range are scanned at intervals, parameters such as a voltage standing wave ratio or a return-loss of the microwaves at different frequencies are calculated, an optimal parameter is then found through comparison, and the frequency corresponding to the optimal parameter is used as the frequency of the generated microwaves. Frequency scanning needs to consume a large quantity of computing resources, and in addition, there are problems such as a slow scanning speed and a low scanning precision. Therefore, the efficiency of absorbing microwave energy is severely affected, resulting in cases such as a high power consumption and overheat of a device.

### SUMMARY

In an embodiment, the present invention provides a microwave generation method for an aerosol-generating device, the method comprising: generating an N^{th} microwave signal by a microwave generation module, N being an integer greater than or equal to 1; detecting a feedback signal corresponding to the N^{th} microwave signal, and generating an adjusting signal according to the feedback signal; and adjusting a control signal according to the adjusting signal by a microwave control module as an adjusted control signal, and sending the adjusted control signal to the microwave generation module.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a microwave generation device according to some embodiments of the present disclosure;

FIG. 2 is a schematic flowchart of a microwave generation method according to some embodiments of the present disclosure;

FIG. 3 is a diagram showing a relationship between the voltage and the frequency of a microwave generation module according to some embodiments of the present disclosure; and

FIG. 4 is a schematic structural diagram of a feedback signal detection module according to some embodiments of the present disclosure.

### DETAILED DESCRIPTION

In an embodiment, the present invention provides an improved microwave generation method and device.

In an embodiment, the present invention provides a microwave generation method, applied to a microwave atomizer, including the following steps:
generating, by a microwave generation module, an N^{th} microwave signal, where N is an integer greater than or equal to 1;
detecting a feedback signal corresponding to the N^{th} microwave signal, and generating an adjusting signal according to the feedback signal; and
adjusting, by a microwave control module, a control signal according to the adjusting signal, and sending the adjusted control signal to the microwave generation module.

Preferably, when N is equal to 1, the step of generating, by a microwave generation module, an N^{th} microwave signal includes: obtaining a preset control signal, and generating the N^{th} microwave signal of a corresponding frequency according to the preset control signal;
when N is greater than 1, the step of generating, by a microwave generation module, an N^{th} microwave signal includes: obtaining the control signal, and adjusting the frequency of an (N−1)^{th} microwave signal according to the control signal, to generate the N^{th} microwave signal.

Preferably, the step of adjusting the frequency of an (N−1)^{th} microwave signal according to the control signal, to generate the N^{th} microwave signal includes:
comparing the control signal and a preset parameter condition, to adjust the frequency of the (N−1)^{th} microwave signal, so as to generate the N^{th} microwave signal.

Preferably, the preset parameter includes a first signal value and a second signal value; and
the step of comparing the control signal and a preset parameter condition, to adjust the frequency of the (N−1)^{th} microwave signal, so as to generate the N^{th} microwave signal includes:
when the control signal is less than or equal to the first signal value, using the frequency of the (N−1)^{th} microwave signal as the frequency of the generated N^{th} microwave signal;
when the control signal is greater than the first signal value and less than the second signal value, increasing the frequency of the (N−1)^{th} microwave signal according to the control signal, and using the increased frequency as the frequency of the generated N^{th} microwave signal;
when the control signal is greater than or equal to the second signal value, obtaining the preset control signal, and using the frequency corresponding to the preset control signal as the frequency of the generated N^{th} microwave signal;
or
when the control signal is less than or equal to the first signal value, using the frequency of the (N−1)^{th} microwave signal as the frequency of the generated N^{th} microwave signal;
when the control signal is greater than the first signal value and less than the second signal value, reducing the frequency of the (N−1)^{th} microwave signal according to the control signal, and using the reduced frequency as the frequency of the generated N^{th} microwave signal; and
when the control signal is greater than or equal to the second signal value, obtaining the preset control signal, and using the frequency corresponding to the preset control signal as the frequency of the generated N^{th} microwave signal.

Preferably, the preset parameter includes a first signal value, a second signal value, a third signal value, and a fourth signal value; and
the step of comparing the control signal and a preset parameter condition, to adjust the frequency of the (N−1)^{th} microwave signal, so as to generate the N^{th} microwave signal includes:
when the control signal is less than or equal to the first signal value or greater than or equal to the second signal value, obtaining the preset control signal, and using the frequency corresponding to the preset control signal as the frequency of the generated N^{th} microwave signal;
when the control signal is greater than the first signal value and less than or equal to the third signal value, increasing the frequency of the (N−1)^{th} microwave signal according to the control signal, and using the increased frequency as the frequency of the generated N^{th} microwave signal;
when the control signal is greater than the third signal value and less than or equal to the fourth signal value, using the frequency of the (N−1)^{th} microwave signal as the frequency of the generated N^{th} microwave signal; and
when the control signal is greater than the fourth signal value and less than the second signal value, reducing the frequency of the (N−1)^{th} microwave signal according to the control signal, and using the reduced frequency as the frequency of the generated N^{th} microwave signal; and

Preferably, the step of generating, by a microwave generation module, an N^{th} microwave signal further includes: adjusting the microwave signal to a set power.

Preferably, the feedback signal includes a forward microwave power and a reverse microwave power; and the forward microwave power is a power at which the microwave signal is transmitted, and the reverse microwave power is a reverse microwave power at which the microwave signal is received.

Preferably, the step of generating an adjusting signal according to the feedback signal includes:
calculating a voltage standing wave ratio according to the feedback signal, and generating the adjusting signal according to the voltage standing wave ratio; or
calculating an return-loss according to the feedback signal, and generating the adjusting signal according to the return-loss; or
generating the adjusting signal according to the difference between the forward microwave power and the reverse microwave power; or
generating the adjusting signal according to the reverse microwave power.

Preferably, before the step of adjusting, by a microwave control module, a control signal according to the adjusting signal, the method further includes: obtaining, by the microwave control module, a preset control signal; and
the step of adjusting, by a microwave control module, a control signal according to the adjusting signal includes: adjusting the control signal according to the difference between the adjusting signal and the preset control signal.

Preferably, the preset control signal is a preset voltage signal set in advance, and the preset voltage signal is a voltage obtained through conversion when the voltage standing wave ratio reaches a required value.

The present disclosure further provides a microwave generation device, including a microwave generation module, a detection module, and a microwave control module;
the microwave generation module being configured to generate an N^{th} microwave signal, where N is an integer greater than or equal to 1; and obtain a control signal sent by the microwave control module;
the detection module being connected to the microwave generation module, and configured to detect a feedback signal corresponding to the N^{th} microwave signal, and generate an adjusting signal according to the feedback signal; and
the microwave control module being separately connected to the microwave generation module and the detection module, and configured to obtain the adjusting signal, adjust the control signal according to the adjusting signal, and send the adjusted control signal to the microwave generation module.

Preferably, the microwave generation module includes a signal source module and a power amplifier;
a first end of the signal source module being connected to the microwave control module, a second end of the signal source module being connected to a first end of the power amplifier, and a second end of the power amplifier being connected to the detection module;
the signal source module being configured to: when N is equal to 1, obtain a preset control signal, and generate the N^{th} microwave signal of a corresponding frequency according to the preset control signal; and when N is greater than 1, obtain the control signal, and adjust the frequency of an (N−1)^{th} microwave signal according to the control signal, to generate the N^{th} microwave signal; and
the power amplifier being configured to adjust the microwave signal to a set power.

Preferably, the signal source module is further configured to compare the control signal and a preset parameter condition, to adjust the frequency of the (N−1)^{th} microwave signal, so as to generate the N^{th} microwave signal.

Preferably, the feedback signal includes a forward microwave power and a reverse microwave power, and the detection module includes a feedback signal detection module and a feedback signal conversion module;
a first end of the feedback signal detection module being connected to the microwave generation module, a second end of the feedback signal detection module being connected to a first end of the feedback signal conversion module, and a second end of the feedback signal conversion module being connected to the microwave control module;
the feedback signal detection module being configured to detect the forward microwave power and the reverse microwave power; and
the feedback signal conversion module being configured to generate an adjusting signal according to the feedback signal.

Preferably, the feedback signal detection module includes a first coupler, a second coupler, and a circulator;
a first end of the first coupler being connected to the microwave generation module, a second end of the first coupler being connected to the input end of the circulator, and a third end of the first coupler being connected to the feedback signal conversion module; the first coupler being configured to detect the forward microwave power, and transfer the forward microwave power to the feedback signal conversion module;
a first end of the second coupler being connected to an isolation end of the circulator, and a second end of the second coupler being connected to the feedback signal conversion module; and the circulator being configured to isolate the reverse microwave power, and the second coupler being configured to detect the reverse microwave power, and transfer the reverse microwave power to the feedback signal conversion module; or
the feedback signal detection module includes a third coupler;
a first end of the third coupler being connected to the microwave generation module, and a second end and a third end of the third coupler being connected to the feedback signal conversion module; and the third coupler being configured to detect the forward microwave power and the reverse microwave power, transfer the forward microwave power to the feedback signal conversion module by the second end of the third coupler, and transfer the reverse microwave power to the feedback signal conversion module by the third end of the third coupler.

Preferably, the microwave control module includes a difference amplifier, the difference amplifier being configured to adjust the control signal according to the difference between the adjusting signal and a preset control signal.

Implementing the microwave generation method and device of the present disclosure has the following beneficial effects: After a microwave signal is generated, a control signal is adjusted by obtaining an outputted feedback signal of the microwave signal, and further, a microwave generated next time can be adjusted according to an output state of the microwave signal, so that the efficiency of absorbing microwave energy can be adjusted in a timely manner, thereby having the advantages such as a rapid adjustment speed and a high precision.

To provide a clearer understanding of the technical features, objectives, and effects of the present disclosure, specific implementations of the present disclosure are described with reference to the accompanying drawings.

When a component is considered to be “connected to” another component, the component may be directly connected to the another component, or an intervening component may be also present. In addition, terms such as “first” and “second” are used merely for the purpose of description, and shall not be construed as indicating or implying relative importance or implying a quantity of indicated technical features. The foregoing terms are merely used for description, and should not be understood as a limitation to this technical solution.

A microwave generation method and device provided in the present disclosure may be applied to a microwave atomizer. The microwave atomizer may heat an aerosol-forming substrate by using microwaves, to form aerosol by atomizing. The aerosol-forming substrate is a solid aerosol-forming medium, for example, a processed plant leaves product. It may be understood that, in some embodiments, the aerosol-forming substrate may alternatively be a liquid aerosol-forming medium.

The microwave atomizer includes a substrate holder for holding the aerosol-forming substrate, an atomizing cavity, a transmit antenna, a microwave generation device, a power supply battery, a housing, and the like. The substrate holder is configured to place and hold the aerosol-forming substrate, the power supply battery is configured to supply power to the microwave atomizer, and the microwave generation device and the power supply battery are located in the housing. The transmit antenna is located at the bottom of the atomizing cavity or at another suitable position, mounted close to the housing, and is configured to transmit a microwave signal. The microwave atomizer further includes a microwave gathering device, and the transmit antenna is located in the microwave gathering device. The transmit antenna emits microwaves, and the microwave gathering device gathers at least some of the microwaves emitted by the transmit antenna to the position where the aerosol-forming substrate is located in the atomizing cavity, so as to heat the aerosol-forming substrate.

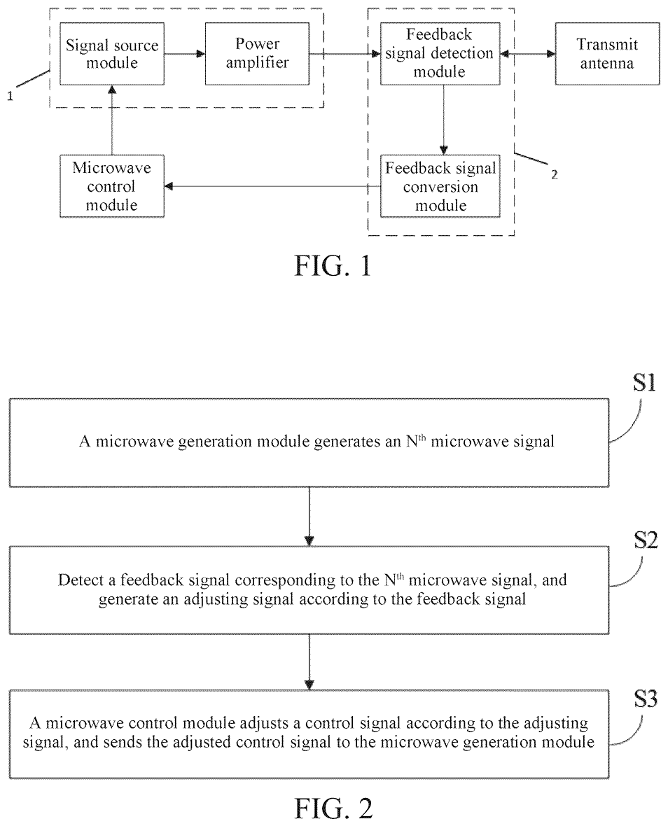

As shown in FIG. 1, in an embodiment, the microwave generation device includes a microwave generation module 1, a detection module 2, and a microwave control module.

The microwave generation module 1 is configured to generate an N^{th} microwave signal, where N is an integer greater than or equal to 1; and obtain a control signal sent by the microwave control module. Specifically, the microwave generation module 1 is separately connected to the microwave control module and the detection module 2. After a microwave signal is generated, the detection module 2 transmits the microwave signal to the transmit antenna, and then the transmit antenna transmits the microwave signal. In addition, the microwave generation module 1 may further receive a start signal and a stop signal from the outside, and work under the control of the start signal and the stop signal.

In an optional embodiment, the microwave generation module 1 includes a signal source module and a power amplifier; a first end of the signal source module being connected to the microwave control module, a second end of the signal source module being connected to a first end of the power amplifier, and a second end of the power amplifier being connected to the detection module 2; the signal source module being configured to: when N is equal to 1, obtain a preset control signal, and generate the N^{th} microwave signal of a corresponding frequency according to the preset control signal; and when N is greater than 1, obtain the control signal, and adjust the frequency of an (N−1)^{th} microwave signal according to the control signal, to generate the N^{th} microwave signal; and the power amplifier being configured to adjust the microwave signal to a set power, so as to control the frequency and power of generated microwaves.

Specifically, the signal source module includes a voltage-controlled oscillator, and the frequency of an output signal of the voltage-controlled oscillator has a mapping relationship with an input control voltage. When the 1^{st} microwave signal is generated, after the preset control signal is obtained, the voltage-controlled oscillator may generate a microwave signal at a default frequency according to the preset control signal. When a microwave signal after the 1^{st} microwave signal is generated, the voltage-controlled oscillator modifies the frequency of the generated microwave signal based on the previous microwave signal according to the control signal, so that the frequency of the microwave signal can be adjusted in real time according to the transmit efficiency of transmitting the previous microwave signal by the transmit antenna. In addition, the power of the microwave signal generated by the voltage-controlled oscillator is relatively low, and therefore the microwave signal outputted by the signal source module needs to be amplified to a required power value by the power amplifier. For example, the power of the microwave signal may be amplified by using a transistor of the model BLM2425M9S20 or another device.

In an optional embodiment, the signal source module is further configured to compare the control signal and a preset parameter condition, to adjust the frequency of the (N−1)^{th} microwave signal, so as to generate the N^{th} microwave signal. Specifically, resistors or other devices may be added, so as to control the voltage-controlled oscillator to specifically adjust the frequency of the microwave signal only when the control signal of the voltage-controlled oscillator meets the preset parameter condition, so that unrestricted adjustment and frequent adjustment of the frequency of the microwave signal are avoided, thereby ensuring the safety of the device.

The detection module 2 is connected between the transmit antenna and the microwave generation module 1, and is configured to: detect a feedback signal corresponding to the N^{th} microwave signal sent by the transmit antenna, and generate an adjusting signal according to the feedback signal. Specifically, the microwave signal is outputted by the detection module 2. For example, the microwave signal is outputted to the transmit antenna, and then the transmit antenna transmits the microwave signal to the aerosol-forming substrate. The resistance of the transmit antenna does not completely match that of the aerosol-forming substrate, and therefore not all of the microwaves can be absorbed by the aerosol-forming substrate, and the microwaves that are not absorbed are reflected back to be received by the antenna. The detection module may obtain, through real-time analysis by detecting the microwave signal transmitted by the transmit antenna and the microwave signal reflected by the transmit antenna, the efficiency by which the microwave signal of the corresponding frequency is absorbed in the aerosol-forming substrate, and generate the adjusting signal, so as to dynamically adjust the frequency of the microwave signal according to the efficiency by which the microwaves are absorbed in the aerosol-forming substrate.

In an optional embodiment, the feedback signal includes a forward microwave power and a reverse microwave power, and the detection module 2 includes a feedback signal detection module and a feedback signal conversion module. A first end of the feedback signal detection module is connected to the microwave generation module 1, a second end of the feedback signal detection module is connected to a first end of the feedback signal conversion module, and a second end of the feedback signal conversion module is connected to the microwave control module. The feedback signal detection module is configured to detect the forward microwave power and the reverse microwave power. The feedback signal conversion module is configured to generate an adjusting signal according to the feedback signal.

Specifically, the forward microwave power is the power of microwaves transmitted by the transmit antenna to the aerosol-forming substrate, and the reverse microwave power is the power of microwaves reflected thereby and received by the transmit antenna. After detecting the forward microwave power and the reverse microwave power, the feedback signal detection module transmits the forward microwave power and the reverse microwave power to the feedback signal conversion module, and the feedback signal conversion module then converts the forward microwave power and the reverse microwave power into a corresponding electrical signal according to the feedback signal.

In an optional embodiment, referring to FIG. 4, the feedback signal detection module includes a first coupler 4, a second coupler 5, and a circulator 3. A first end of the first coupler 4 is connected to the microwave generation module, a second end of the first coupler 4 is connected to the input end of the circulator 3, a third end of the first coupler 4 is connected to the feedback signal conversion module, and a fourth end of the first coupler 4 is connected to a resistor; and the first coupler 4 is configured to detect the forward microwave power, and transfer the forward microwave power to the feedback signal conversion module. A first end of the second coupler 5 is connected to an isolation end of the circulator, a second end of the second coupler 5 is connected to the feedback signal conversion module, and a third end of the second coupler 5 is connected to another resistor. The circulator 3 is configured to isolate the reverse microwave power, and the second coupler 5 is configured to detect the reverse microwave power, and transfer the reverse microwave power to the feedback signal conversion module.

Specifically, when the microwave signal passes through the first coupler 4, the first coupler 4 may form a forward microwave power by coupling according to a particular proportion, so as to detect the forward microwave power; the microwave signal that passes through the first coupler 4 is inputted to the input end of the circulator 3, and then is outputted from the output end thereof to the transmit antenna; after the transmit antenna sends the microwave signal to the aerosol-forming substrate, part of the microwave signal is reflected back to the transmit antenna to form a reverse microwave signal; the reverse microwave signal enters from the output end of the circulator and is separated by the circulator, to then arrive at the isolation end, so as to be further transmitted to the second coupler 5; and the second coupler 5 also forms a reverse microwave power by coupling according to a particular proportion, so as to detect the reverse microwave power.

Alternatively, in another optional embodiment, the feedback signal detection module includes a third coupler. A first end of the third coupler is connected to the microwave generation module, and a second end and a third end of the third coupler are connected to the feedback signal conversion module; and the third coupler is configured to detect the forward microwave power and the reverse microwave power, transfer the forward microwave power to the feedback signal conversion module by the second end of the third coupler, and transfer the reverse microwave power to the feedback signal conversion module by the third end of the third coupler.

Specifically, the third coupler may be a dual-directional coupler. When the microwave signal passes through the third coupler, the third coupler may form a forward microwave power by coupling according to a particular proportion, so as to detect the forward microwave power; the microwave signal that passes through the third coupler arrives at the transmit antenna; after the transmit antenna sends the microwave signal to the aerosol-forming substrate, part of the microwave signal is reflected back to the transmit antenna to form a reverse microwave signal; and the reverse microwave signal is further transmitted to the third coupler, the third coupler then forms a reverse microwave power by coupling according to a particular proportion, so as to detect the reverse microwave power.

In an optional embodiment, the feedback signal conversion module generates an adjusting signal according to the feedback signal. The feedback signal conversion module may perform conversion according to an input power signal to output a voltage signal by using a power detector, for example, a MAX2016 power detector or an LT5581 power detector.

The microwave control module is separately connected to the microwave generation module 1 and the detection module 2, and configured to obtain the adjusting signal, adjust the control signal according to the adjusting signal, and send the adjusted control signal to the microwave generation module 1.

In an optional embodiment, the microwave control module includes a difference amplifier, the difference amplifier being configured to adjust the control signal according to the difference between the adjusting signal and a preset control signal. Specifically, the difference amplifier may output a voltage that is proportional to the difference between voltages at two input ends, and may output one voltage signal, that is, the control signal, by performing proportional amplification according to the difference between the two voltage signals, that is, the adjusting signal and the preset control signal. A specific amplification proportion is correlated with a specific circuit setting of the difference amplifier.

In an optional embodiment, the preset control signal is a preset voltage signal set in advance, and the preset voltage signal is a voltage obtained through conversion when the voltage standing wave ratio (VSWR) reaches a required value. Specifically, the preset control signal is kept unchanged, and is a voltage obtained through conversion in advance when VSWR<X. The value of X may differ according to the actual requirements, for example, 1.5 or 1.4. Due to the fact that the resistance of the aerosol-forming substrate changes and the default frequency corresponding to the preset control signal is not necessarily the optimal working frequency, the control signal inputted to the microwave generation module 1 needs to be adjusted in combination with the preset control signal and the adjusting signal.

The operation process of the microwave generation device in this embodiment includes: after the microwave generation module 1 receives a start signal, obtaining a preset control signal as a control signal, generating microwaves of the frequency corresponding to the preset control signal, transmitting the microwaves to the transmit antenna by the detection module 2, transmitting the microwaves to the aerosol-forming substrate by the transmit antenna, detecting the feedback signal and generating an adjusting signal by the detection module 2, adjusting the control signal according to the adjusting signal by the microwave control module, adjusting or continuously maintaining the power of generated microwaves according to the control signal by the microwave generation module 1, and further continuously outputting the microwaves by the detection module. The process is repeated, until the microwave generation module 1 receives a stop signal.

According to the microwave generation device in this embodiment, automatic frequency tracking by a hardware circuit is implemented by using a negative feedback automatic control logic, and the speed of the automatic frequency tracking depends on a hardware conversion speed, and is far higher than the frequency tracking speed controlled by software. Moreover, the computing resources of the control module do not need to be consumed.

As shown in FIG. 2, FIG. 2 is a schematic flowchart of a microwave generation method according to an embodiment of the present disclosure. The microwave generation method in this embodiment may be applied to a microwave atomizer, and includes the following steps.

S1: A microwave generation module generates an N^{th} microwave signal, where N is an integer greater than or equal to 1. Specifically, after receiving a start signal sent by an external control system, the microwave generation module 1 may continuously generate microwave signals according to input voltages, then the microwave signals arrive at a transmit antenna through a detection module 2, for the transmit antenna to transmit microwaves to an aerosol-forming substrate. The microwave generation module 1 keeps working, until a stop signal sent by the external control system is received.

In an optional embodiment, the preset control signal is a preset voltage signal set in advance, and the preset voltage signal is a voltage obtained through conversion when the voltage standing wave ratio (VSWR) reaches a required value. Specifically, the preset control signal is a voltage obtained by conversion according to an actual requirement for the value of the voltage standing wave ratio, that is, when VSWR<X. The value of X may differ according to the actual requirements, for example, 1.5 or 1.4. The voltage standing wave ratio may be used for measuring the efficiency by which the microwave power is transmitted to the aerosol-forming substrate by the transmit antenna. When resistance of the transmit antenna is inconsistent with that of the aerosol-forming substrate, part of the microwave power may be reflected back, resulting in reduction in the power transmitted to the aerosol-forming substrate, and a higher reflected power indicates a larger voltage standing wave ratio.

In an optional embodiment, when N is equal to 1, the generating, by the microwave generation module, an N^{th} microwave signal in step S1 includes: obtaining a preset control signal, and generating the N^{th} microwave signal of a corresponding frequency according to the preset control signal. When N is greater than 1, the generating, by a microwave generation module, an N^{th} microwave signal in step S1 includes: obtaining a control signal, and adjusting the frequency of an (N−1)^{th} microwave signal according to the control signal, to generate the N^{th} microwave signal.

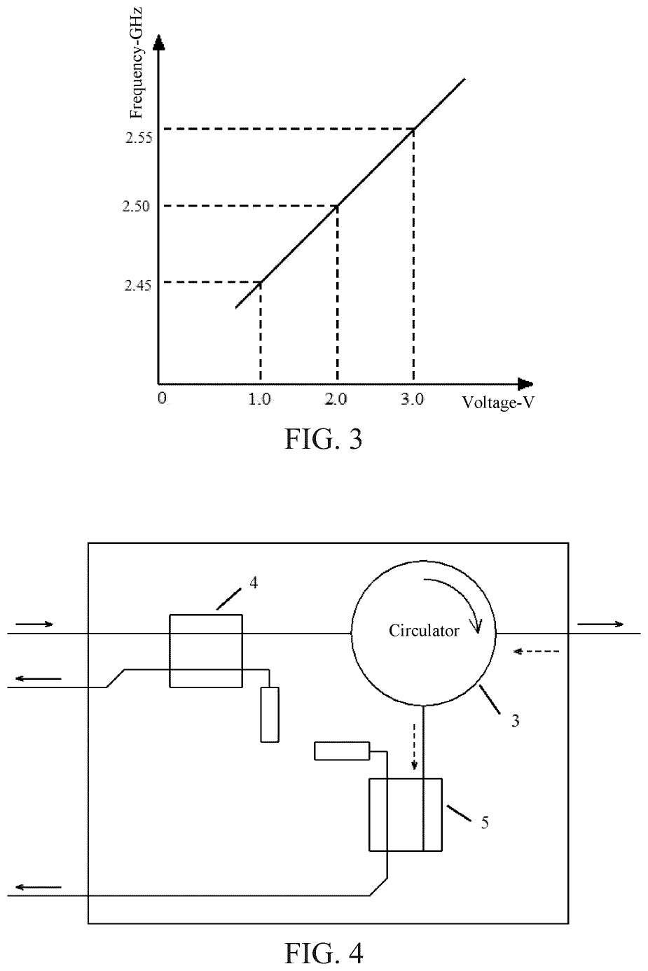

Specifically, when the 1^{st} microwave signal is generated, after the preset control signal is obtained, a microwave signal at a default frequency may be generated according to the preset control signal. For example, referring to FIG. 3, when the preset control signal is 1 V, the voltage-controlled oscillator outputs, according to the inputted voltage of 1 V, a default microwave signal having the frequency of 2.45 GHz and the power of 0 dBm.

When a microwave signal after the 1^{st} microwave signal is generated, the frequency of the generated microwave signal is adjusted based on the previous microwave signal according to the control signal, so that the frequency of the microwave signal can be adjusted in real time according to the transmit efficiency of transmitting the previous microwave signal by the transmit antenna.

In an optional embodiment, step S1 further includes: adjusting the microwave signal to a set power. Specifically, due to the fact that the power of the microwave signal generated by the voltage-controlled oscillator is relatively low, the power of the microwave signal needs to be amplified to a required power value. For example, the power of the microwave signal is amplified from 0 dBm to 40 dBm, where dBm uses the power of 1 mW as the reference and is used for representing an absolute power value.

S2: Detect a feedback signal corresponding to the N^{th} microwave signal, and generate an adjusting signal according to the feedback signal. Specifically, by detecting the feedback signal corresponding to the transmitted microwaves by the detection module 2, the situation of absorption of the microwaves having the corresponding frequency by the aerosol-forming substrate can be obtained. Therefore, the adjusting signal generated according to the feedback signal can be used for adjusting the control signal so as to adjust the frequency of the microwaves, so that the generated microwave energy is maximally absorbed by the aerosol-forming substrate.

In an optional embodiment, the feedback signal includes a forward microwave power and a reverse microwave power; and the forward microwave power is a power at which the microwave signal is transmitted, and the reverse microwave power is a reverse microwave power at which the microwave signal is received. Specifically, microwaves that are not absorbed by the aerosol-forming substrate may be reflected to be received by the antenna, and the power of the microwaves is the reverse microwave power. The forward microwave power is the power of microwaves transmitted by a transmit antenna to the aerosol-forming substrate. The forward microwave power and the reverse microwave power may be detected by using a coupler and a circulator.

For example, the 1^{st} microwave signal undergone the power amplification has the frequency of 2.45 GHz and the power of 40 dBm, and after the 1^{st} microwave signal arrives at the feedback signal detection module, part of the power is obtained by coupling. Assuming that the coupling coefficient is −20 dBm, the forward microwave power detected by the feedback signal detection module is: 40 dBm−20 dBm=20 dBm. In addition, the power of the 1^{st} microwave signal passing through the feedback signal detection module is attenuated by 1 dBm, and the 1^{st} microwave signal arriving at the transmit antenna has the frequency of 2.45 GHz and the power of 39 dBm (7.943 W). Assuming that the reverse microwaves returned to the transmit antenna has the frequency of 2.45 GHz and the power of 36 dBm (3.981 W), the power reflectivity in this case is approximately 50%, and the reverse microwave power detected by the feedback signal detection module is 36 dBm−20 dBm=16 dBm. Due to the fact that the coupling coefficient is unchanged, the transmit efficiency of the microwave signal can still be obtained by selecting to only detect the coupled part for detection of the forward microwave power and the reverse microwave power.

In an optional embodiment, the generating an adjusting signal according to the feedback signal in step S2 includes: calculating a voltage standing wave ratio according to the feedback signal, and generating the adjusting signal according to the voltage standing wave ratio; or calculating an return-loss according to the feedback signal, and generating the adjusting signal according to the return-loss; or generating the adjusting signal according to the difference between the forward microwave power and the reverse microwave power; or generating the adjusting signal according to the reverse microwave power.

Specifically, when the power of the forward microwave signal is unchanged, a lower power of the reverse microwave signal indicates a higher absorbing efficiency of the microwave signal. Therefore, the adjusting signal generated according to the feedback signal facilitates evaluation of the absorbing efficiency the microwave signal at the current frequency by the microwave control module. Therefore, the adjusting signal may be obtained by converting the voltage standing wave ratio, the return-loss, the reverse microwave power value, or the difference between the forward microwave power and the reverse microwave power to output a voltage signal. For example, the adjusting signal is converted into 1.6 V according to the reverse microwave power value of 16 dBm; the adjusting signal is converted into 0.4 V according to the difference of 4 dBm between the forward microwave power and the reverse microwave power; the adjusting signal is converted into 0.3 V according to the voltage standing wave ratio of 3; and the adjusting signal is converted into 0.6 V according to the return-loss of 6 dB.

S3: A microwave control module adjusts a control signal according to the adjusting signal, and sends the adjusted control signal to the microwave generation module 1. Specifically, due to the fact that different frequencies have different transmit efficiencies of microwave signals, a suitable microwave signal frequency meeting a transmit efficiency requirement needs to be found. The control signal inputted to the microwave generation module 1 is adjusted according to the adjusting signal, the adjusted control signal is sent to the microwave generation module 1, and then the microwave generation module 1 adjusts the frequency of the microwave signal according to the adjusted control signal, so that the frequency of the microwave signal can be dynamically adjusted to adapt to the continuous changes of the resistance.

In an optional embodiment, before step S3, the method further includes: obtaining, by the microwave control module, a preset control signal; and the step of adjusting, by a microwave control module, a control signal according to the adjusting signal in step S3 includes: adjusting the control signal according to the difference between the adjusting signal and the preset control signal. Specifically, the adjusting signal and the preset control signal are separately inputted to the difference amplifier, and the control signal may be obtained through conversion according to the difference between voltage values of the adjusting signal and the preset control signal by a particular proportion.

For example, when the microwave signal is generated for the first time, the adjusting signal obtained through conversion according to the reverse microwave power value is 1.6 V, the preset control signal is 1 V, and the difference between the adjusting signal and the preset control signal is 0.6 V; assuming that the difference between the adjusting signal and the preset control signal is used as the control signal, the control signal is 0.6 V. Adjusting signals obtained according to different conversion modes are correspondingly different. Therefore, the specific conversion relationship of the difference between the adjusting signal and the preset control signal needs to be correspondingly adjusted.

In an optional embodiment, the adjusting the frequency of an (N−1)^{th} microwave signal according to the control signal, to generate an N^{th} microwave signal in step S1 includes: comparing the control signal and a preset parameter condition, to adjust the frequency of the (N−1)^{th} microwave signal, so as to generate the N^{th} microwave signal. Specifically, according to an actual requirement, the frequency of the microwave signal cannot be increased or reduced unlimitedly. Therefore, some conditions need to be set, the control signal is compared with parameter conditions, and the frequency of the microwave signal is controlled according to requirements of the conditions.

In an optional embodiment, the preset parameter includes a first signal value and a second signal value. The comparing the control signal and a preset parameter condition, to adjust the frequency of the (N−1)^{th} microwave signal, so as to generate the N^{th} microwave signal in step S1 includes: when the control signal is less than or equal to the first signal value, using the frequency of the (N−1)^{th} microwave signal as the frequency of the generated N^{th} microwave signal; when the control signal is greater than the first signal value and less than the second signal value, increasing the frequency of the (N−1)^{th} microwave signal according to the control signal, and using the increased frequency as the frequency of the generated N^{th} microwave signal; and when the control signal is greater than or equal to the second signal value, obtaining the preset control signal, and using the frequency corresponding to the preset control signal as the frequency of the generated N^{th} microwave signal.

For example, referring to FIG. 3, the first signal value VA is 0.5 V, and the second signal value VB is 2 V; and each time the voltage is increased by 1 V, the frequency is increased by 0.05 GHz. The frequency of the (N−1)^{th} microwave signal is 2.45 GHZ. When the control signal obtained according to the (N−1)^{th} microwave signal is 0.6 V, the amplitude by which the frequency is increased corresponds to the amplitude of 0.6 V by which the voltage is increased, the frequency needs to be increased by 0.03 GHZ, and the frequency of the generated N^{th} microwave signal is 2.48 GHz. When the control signal obtained according to the N^{th} microwave signal is 0.4 V, the frequency is kept unchanged, and the frequency of a generated (N+1)^{th} microwave signal is still 2.48 GHz. When the control signal obtained according to the (N+1)^{th} microwave signal is 2.1 V, the preset signal is reset to the default frequency corresponding to the preset control signal of 1 V, and the frequency of a generated (N+2)^{th} microwave signal is 2.45 GHZ.

In another optional embodiment, the comparing the control signal and a preset parameter condition, to adjust the frequency of the (N−1)^{th} microwave signal, so as to generate the N^{th} microwave signal in step S1 includes: when the control signal is less than or equal to the first signal value, using the frequency of the (N−1)^{th} microwave signal as the frequency of the generated N^{th} microwave signal; and when the control signal is greater than the first signal value and less than the second signal value, reducing the frequency of the (N−1)^{th} microwave signal according to the control signal, and using the reduced frequency as the frequency of the generated N^{th} microwave signal.

For example, referring to FIG. 3, the first signal value VA is 0.5 V, and the second signal value VB is 2 V. The frequency of the (N−1)^{th} microwave signal is 2.45 GHZ. When the control signal obtained according to the (N−1)^{th} microwave signal is 0.6 V, the amplitude at which the frequency is reduced corresponds to the amplitude of 0.6 V at which the voltage reduced, the frequency needs to be reduced by 0.03 GHZ, and the frequency of the generated N^{th} microwave signal is 2.42 GHz. When the control signal obtained according to the N^{th} microwave signal is 0.4 V, the frequency is kept unchanged, and the frequency of a generated (N+1)^{th} microwave signal is still 2.42 GHz. When the control signal obtained according to the (N+1)^{th} microwave signal is 2.1 V, the preset signal is reset to the default frequency corresponding to the preset control signal of 1 V, and the frequency of a generated (N+2)^{th} microwave signal is 2.45 GHz.

In an optional embodiment, the preset parameter includes a first signal value, a second signal value, a third signal value, and a fourth signal value. The comparing the control signal and a preset parameter condition, to adjust the frequency of the (N−1)^{th} microwave signal, so as to generate the N^{th} microwave signal in step S1 includes:
when the control signal is less than or equal to the first signal value or greater than or equal to the second signal value, obtaining the preset control signal, and using the frequency corresponding to the preset control signal as the frequency of the generated N^{th} microwave signal; when the control signal is greater than the first signal value and less than or equal to the third signal value, increasing the frequency of the (N−1)^{th} microwave signal according to the control signal, and using the increased frequency as the frequency of the generated N^{th} microwave signal; when the control signal is greater than the third signal value and less than or equal to the fourth signal value, using the frequency of the (N−1)^{th} microwave signal as the frequency of the generated N^{th} microwave signal; and when the control signal is greater than the fourth signal value and less than the second signal value, reducing the frequency of the (N−1)^{th} microwave signal according to the control signal, and using the reduced frequency as the frequency of the generated N^{th} microwave signal.

For example, referring to FIG. 3, the first signal value VA is 0.5 V, the second signal value VB is 2 V, the third signal value Va is 1 V, and the fourth signal value Vb is 1.5 V. The frequency of the (N−1)^{th} microwave signal is 2.45 GHz. When the control signal obtained according to the (N−1)^{th} microwave signal is 0.8 V, the amplitude by which the frequency is increased corresponds to the amplitude of 0.8 V by which the voltage is increased. The frequency needs to be increased by 0.04 GHZ, and the frequency of the generated N^{th} microwave signal is 2.49 GHz. When the control signal obtained according to the N^{th} microwave signal is 1.1 V, the frequency is kept unchanged, and the frequency of a generated (N+1)^{th} microwave signal is still 2.49 GHz. When the control signal obtained according to the (N+1)^{th} microwave signal is 1.6 V, the amplitude at which the frequency is reduced corresponds to the amplitude at which the voltage is reduced by 1.6 V, the frequency needs to be reduced by 0.08 GHz, and the frequency at which the (N+2)^{th} microwave signal is generated is 2.41 GHz. When the control signal obtained according to the (N+2)^{th} microwave signal is 2.1 V or 0.4 V, the preset signal is reset to the default frequency corresponding to the preset control signal of 1 V, and the frequency at which an (N+3)^{th} microwave signal is generated is 2.45 GHz.

According to the microwave generation method in this embodiment, automatic frequency tracking by a hardware circuit by using a negative feedback automatic control logic, and the speed of the automatic frequency tracking depends on a hardware conversion speed, and is far higher than the frequency tracking speed controlled by software. Moreover, the computing resources of the control module do not need to be consumed.

The embodiments in this specification are all described in a progressive manner. Description of each of the embodiments focuses on differences from other embodiments, and reference may be made to each other for the same or similar parts among the embodiments.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave generation method for an aerosol-generating device, the method comprising:
generating an N^{th} microwave signal by a microwave generation module, N being an integer greater than or equal to 1;
detecting a feedback signal corresponding to the N^{th} microwave signal, and generating an adjusting signal according to the feedback signal; and
adjusting a control signal according to the adjusting signal by a microwave control module as an adjusted control signal, and sending the adjusted control signal to the microwave generation module.

2. The microwave generation method of claim 1, wherein, when N is equal to 1, generating the N^{th} microwave signal comprises: obtaining a preset control signal, and generating the N^{th} microwave signal of a corresponding frequency according to the preset control signal, and
wherein, when N is greater than 1, generating the N^{th} microwave signal comprises: obtaining the control signal, and adjusting the frequency of an (N−1)^{th} microwave signal according to the control signal, to generate the N^{th} microwave signal.

3. The microwave generation method of claim 2, wherein adjusting the frequency of the (N−1)^{th} microwave signal according to the control signal, to generate the N^{th} microwave signal, comprises:
comparing the control signal and a preset parameter condition, to adjust the frequency of the (N−1)^{th} microwave signal, so as to generate the N^{th} microwave signal.

4. The microwave generation method of claim 3, wherein the preset parameter comprises a first signal value and a second signal value; and
wherein comparing the control signal and a preset parameter condition, to adjust the frequency of the (N−1)^{th} microwave signal, so as to generate the N^{th} microwave signal comprises:
when the control signal is less than or equal to the first signal value, using the frequency of the (N−1)^{th} microwave signal as the frequency of the generated N^{th} microwave signal;
when the control signal is greater than the first signal value and less than the second signal value, increasing the frequency of the (N−1)^{th} microwave signal according to the control signal, and using the increased frequency as the frequency of the generated N^{th} microwave signal;
when the control signal is greater than or equal to the second signal value, obtaining the preset control signal, and using the frequency corresponding to the preset control signal as the frequency of the generated N^{th} microwave signal; or
when the control signal is less than or equal to the first signal value, using the frequency of the (N−1)^{th} microwave signal as the frequency of the generated N^{th} microwave signal;
when the control signal is greater than the first signal value and less than the second signal value, reducing the frequency of the (N−1)^{th} microwave signal according to the control signal, and using the reduced frequency as the frequency of the generated N^{th} microwave signal; and
when the control signal is greater than or equal to the second signal value, obtaining the preset control signal, and using the frequency corresponding to the preset control signal as the frequency of the generated N^{th} microwave signal.

5. The microwave generation method of claim 3, wherein the preset parameter comprises a first signal value, a second signal value, a third signal value, and a fourth signal value; and
wherein comparing the control signal and a preset parameter condition, to adjust the frequency of the (N−1)^{th} microwave signal, so as to generate the N^{th} microwave signal comprises:
when the control signal is less than or equal to the first signal value or greater than or equal to the second signal value, obtaining the preset control signal, and using the frequency corresponding to the preset control signal as the frequency of the generated N^{th} microwave signal;
when the control signal is greater than the first signal value and less than or equal to the third signal value, increasing the frequency of the (N−1)^{th} microwave signal according to the control signal to produce an increased frequency, and using the increased frequency as the frequency of the generated N^{th} microwave signal;
when the control signal is greater than the third signal value and less than or equal to the fourth signal value, using the frequency of the (N−1)^{th} microwave signal as the frequency of the generated N^{th} microwave signal; and
when the control signal is greater than the fourth signal value and less than the second signal value, reducing the frequency of the (N−1)^{th} microwave signal according to the control signal to produce a reduced frequency, and using the reduced frequency as the frequency of the generated N^{th} microwave signal.

6. The microwave generation method of claim 1, wherein generating, by the microwave generation module, the N^{th} microwave signal further comprises: adjusting the microwave signal to a set power.

7. The microwave generation method of claim 1, wherein the feedback signal comprises a forward microwave power and a reverse microwave power, and
wherein the forward microwave power comprises a power at which the microwave signal is transmitted, and the reverse microwave power comprises a reverse microwave power at which the microwave signal is received.

8. The microwave generation method of claim 7, wherein generating the adjusting signal according to the feedback signal comprises:
calculating a voltage standing wave ratio according to the feedback signal, and generating the adjusting signal according to the voltage standing wave ratio; or
calculating a return-loss according to the feedback signal, and generating the adjusting signal according to the return-loss; or
generating the adjusting signal according to a difference between the forward microwave power and the reverse microwave power; or
generating the adjusting signal according to the reverse microwave power.

9. The microwave generation method of claim 1, wherein, before adjusting, by the microwave control module, the control signal according to the adjusting signal, the method comprises: obtaining, by the microwave control module, a preset control signal, and
wherein adjusting, by the microwave control module, the control signal according to the adjusting signal comprises: adjusting the control signal according to a difference between the adjusting signal and the preset control signal.

10. The microwave generation method of claim 2, wherein the preset control signal comprises a preset voltage signal set in advance, and
wherein the preset voltage signal comprises a voltage obtained through conversion when the voltage standing wave ratio reaches a required value.

11. A microwave generation device, comprising:
a microwave generation module;
a detection module; and
a microwave control module;
wherein the microwave generation module is configured to generate an N^{th} microwave signal, N being an integer greater than or equal to 1, and obtain a control signal sent by the microwave control module;
wherein the detection module is connected to the microwave generation module, and configured to detect a feedback signal corresponding to the N^{th} microwave signal and generate an adjusting signal according to the feedback signal, and
wherein the microwave control module is connected to the microwave generation module and the detection module, and configured to obtain the adjusting signal, adjust the control signal according to the adjusting signal, and send the adjusted control signal to the microwave generation module.

12. The microwave generation device of claim 11, wherein the microwave generation module comprises a signal source module and a power amplifier,
wherein a first end of the signal source module is connected to the microwave control module, a second end of the signal source module is connected to a first end of the power amplifier, and a second end of the power amplifier is connected to the detection module,
wherein the signal source module is configured to: when N is equal to 1, obtain a preset control signal, and generate the N^{th} microwave signal of a corresponding frequency according to the preset control signal; and, when N is greater than 1, obtain the control signal, and adjust the frequency of an (N−1)^{th} microwave signal according to the control signal, to generate the N^{th} microwave signal, and
wherein the power amplifier is configured to adjust the microwave signal to a set power.

13. The microwave generation device of claim 12, wherein the signal source module is configured to compare the control signal and a preset parameter condition, to adjust the frequency of the (N−1)^{th} microwave signal, so as to generate the N^{th} microwave signal.

14. The microwave generation device of claim 11, wherein the feedback signal comprises a forward microwave power and a reverse microwave power, and the detection module comprises a feedback signal detection module and a feedback signal conversion module,
wherein a first end of the feedback signal detection module is connected to the microwave generation module, a second end of the feedback signal detection module is connected to a first end of the feedback signal conversion module, and a second end of the feedback signal conversion module is connected to the microwave control module,
wherein the feedback signal detection module is configured to detect the forward microwave power and the reverse microwave power, and
wherein the feedback signal conversion module is configured to generate an adjusting signal according to the feedback signal.

15. The microwave generation device of claim 14, wherein the feedback signal detection module comprises a first coupler, a second coupler, and a circulator,
wherein a first end of the first coupler is connected to the microwave generation module, a second end of the first coupler is connected to the input end of the circulator, and a third end of the first coupler is connected to the feedback signal conversion module, the first coupler being configured to detect the forward microwave power, and transfer the forward microwave power to the feedback signal conversion module, and
wherein a first end of the second coupler is connected to an isolation end of the circulator, and a second end of the second coupler is connected to the feedback signal conversion module, and the circulator is configured to isolate the reverse microwave power, and the second coupler is configured to detect the reverse microwave power, and transfer the reverse microwave power to the feedback signal conversion module, or
wherein the feedback signal detection module comprises a third coupler, and
wherein a first end of the third coupler is connected to the microwave generation module, and a second end and a third end of the third coupler is connected to the feedback signal conversion module, and the third coupler is configured to detect the forward microwave power and the reverse microwave power, transfer the forward microwave power to the feedback signal conversion module by the second end of the third coupler, and transfer the reverse microwave power to the feedback signal conversion module by the third end of the third coupler.

16. The microwave generation device of claim 11, wherein the microwave control module comprises a difference amplifier configured to adjust the control signal according to a difference between the adjusting signal and a preset control signal.
